(19) United States
(12) Patent Application Publication
(10) Pub. No.: US 2003/0107462 A1
(43) Pub. Date: Jun. 12, 2003

(54) Flyback transformer and device for holding bleeder resistor in such transformer

(75) Inventor: Dong Hwan Cho, Hwasung-gun (KR)

Correspondence Address: LOWE HAUPTMAN GOPSTEIN, GILMAN & BERNER, LLP, Suite 310, 1700 Diagonal Road, Alexandria, VA, 22314, US

(73) Assignee: Samsung Electro-Mechanics Co., Ltd.

(21) Appl. No.: 10/124,472

(22) Filed: Apr. 18, 2002

(30) Foreign Application Priority Data
Dec. 10, 2001 (KR) 2001-77888

(51) Int. Cl. H01F 27/30

(52) U.S. Cl. 336/198

(57) ABSTRACT

A flyback transformer, used as a high voltage generator for supplying a high voltage to the CRT of a TV receiver or a monitor, and a bleeder resistor holding device for such transformers is disclosed. The bleeder resistor holding device is designed to hold a bleeder resistor at a position between a high voltage bobbin and a low voltage bobbin of the transformer, thus accomplishing compactness and smallness of a focus pack of the transformer. In the flyback transformer of this invention, the bleeder resistor is positioned at a gap defined between the pin terminals of the high voltage bobbin and the low voltage bobbin such that the bleeder resistor is spaced apart from the pin terminal of the low voltage bobbin by a predetermined distance.

### BACKGROUND OF THE INVENTION

1. Field of the Invention

The present invention relates, in general, to flyback transformers used as high voltage generators for supplying high voltages to the CRTs of TV receivers or monitors and, more particularly, to a flyback transformer having a structurally improved bleeder resistor holding structure, which is designed to hold a bleeder resistor at a position between a high voltage bobbin and a low voltage bobbin of the flyback transformer, thus accomplishing compactness and smallness of a focus pack of the transformer.

2. Description of the Prior Art

FIG. 1 is a perspective view, showing the construction of a conventional bleeder resistor for flyback transformers (hereinbelow, referred to simply as “FBT”). As shown in the drawing, the bleeder resistor consists of a focus pack board 110 and a bleeder resistor board 170. The FBT focus pack board 110 is printed on its top surface with two screen focus resistor patterns 120 and 130. Two screen focus voltage output terminals 140 are provided at the centers of the two resistor patterns 120 and 130, respectively. In addition, two screen focus voltage input terminals 150 are provided at the outer ends of the two resistor patterns 120 and 130, respectively. The bleeder resistor board 170, printed on its top surface with a resistor pattern 160, is positioned at a side of the focus pack board 110, and is connected to the focus pack board 110, thus forming a bleeder resistor.

FIG. 2 shows a conventional structure for holding such a bleeder resistor in an FBT. As shown in the drawing, the bleeder resistor 207 is held in an EBT by both a resistor holder 205 formed in a focus pack 201 and a resistor insert groove 204 formed in an FBT casing 203. A high voltage bobbin 208 is inserted in the FBT casing 203. However, this bleeder resistor holding structure is problematic in that it is necessary to secure additional space in the focus pack 203 for holding the bleeder resistor 207. Therefore, this holding structure fails to accomplish the recent trend of compactness or smallness of the focus pack 201.

In an effort to overcome the above-mentioned problem, an FBT of FIG. 3 having a structurally improved bleeder resistor holding structure has been used. The FBT of FIG. 3 is disclosed in Korean Utility Model Publication No. 87-4463. In this FBT, a resistor holder 303 is integrally formed at a coil separating wall 302 of a high voltage bobbin 301, with a resistor holding channel 305 formed in the resistor holder 303. A bleeder resistor 304 is inserted in the holding channel 305 of the holder 303 such that the resistor 304 is positioned at a side of the high voltage bobbin 301 while extending outside the bobbin 301 in an axial direction of the bobbin 301. This bleeder resistor holding structure is advantageous in that it accomplishes smallness of the FBT. However, this structure is problematic in that the bleeder resistor 304 may interfere with the high voltage output coils of the high voltage bobbin 301. The above holding structure also undesirably increases the length of the bleeder resistor 304 by the length of the bobbin 301, thus enlarging the size of the bleeder resistor 304 and increasing the production cost of the bleeder resistors.

In an effort to accomplish compactness and smallness of FBTs, in addition to providing a stable structure for holding the bleeder resistors in the FBTs, an FBT having another bleeder resistor holding structure of FIG. 4 was proposed. This FBT is disclosed in Japanese Patent laid-open Publication No. Heisei. 7-75339. In this FBT, a bleeder resistor 401 consisting of a plurality of small boards is held on a high voltage bobbin 403 while being connected to the high voltage output coils 405 and the diodes 407 of the bobbin 403. Since this FBT uses the bleeder resistor 401 consisting of the small-sized boards, it is possible to accomplish compactness and smallness of the FBTs, in addition to providing a stable structure for holding the bleeder resistor 401 in the FBT without causing interference of the bleeder resistor 401 with the high voltage output coils 405 of the high voltage bobbin 403. However, since the small boards of the bleeder resistor 401 are held at positions between the high voltage output coils 405 and the diodes 407 of the bobbin 403, it is difficult to produce the EBT. Another problem of this FBT resides in that it is necessary to provide a complex circuit for connecting the small boards of the bleeder resistor 401 to the high voltage output coils 405 and the diodes 407 of the bobbin 403.

Therefore, it has been required to provide a bleeder resistor holding structure for FBTs, which accomplishes compactness and smallness of the FBTS, stably holds bleeder resistors in the FBTs while allowing the bleeder resistors to have a desired size, and easily receives a bleeder resistor when installing the bleeder resistor in an FBT.

### SUMMARY OF THE INVENTION

Accordingly, the present invention has been made keeping in mind the above problems occurring in the prior art, and an object of the present invention is to provide a bleeder resistor holding device for FBTs, which holds a bleeder resistor at a gap defined between a high voltage bobbin and a low voltage bobbin of an FBT, thus accomplishing compactness and smallness of the FBT and reducing the production cost of the FBT, and which easily receives the bleeder resistor when installing the bleeder resistor in the FBT.

Another object of the present invention is to provide a bleeder resistor holding device for FBTs, which stably holds a bleeder resistor in an FBT at a gap defined between the high voltage bobbin and the low voltage bobbin.

A further object of the present invention is to provide an FBT having such a bleeder resistor holding device.

In order to accomplish the above objects, the present invention provides a flyback transformer, comprising: a high voltage bobbin and a low voltage bobbin, each provided with a pin terminal, in addition to an internal coil used for generating a high voltage; an FBT casing receiving both the high voltage bobbin and the low voltage bobbin, and electrically insulated by an insulating resin; and a bleeder resistor consisting of a ceramic board printed with a resistor pattern on the top surface thereof, the bleeder resistor being positioned at a gap defined between the pin terminals of the high voltage bobbin and the low voltage bobbin such that the bleeder resistor is spaced apart from the pin terminal of the low voltage bobbin by a predetermined distance.

The present invention also provides a device for holding a bleeder resistor in such a flyback transformer, comprising: a resistor holding means projecting from at least one of the high voltage bobbin and the low voltage bobbin at a position between pin terminals of the high voltage bobbin and the low voltage bobbin, the holding means receiving an end of the ceramic board of the bleeder resistor for holding the bleeder resistor in the flyback transformer, whereby the bleeder resistor held by the holding means is positioned at a gap defined between the pin terminals of the high voltage bobbin and the low voltage bobbin such that the bleeder resistor is spaced apart from the pin terminal of the low voltage bobbin by a predetermined distance.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing the construction of a conventional bleeder resistor for flyback transformers, including a focus pack board and a bleeder resistor board;

FIG. 2 is an exploded perspective view of an FBT having a bleeder resistor holding structure according to an embodiment of the prior art;

FIG. 3 is a view of an FBT having a bleeder resistor holding structure according to another embodiment of the prior art;

FIG. 4 is a perspective view of an FBT having a bleeder resistor holding structure according to a further embodiment of the prior art;

FIG. 5 is an exploded perspective view, showing the construction of a high voltage bobbin and a low voltage bobbin of an FBT having a bleeder resistor holding device in accordance with the preferred embodiment of the present invention;

FIG. 6 is a perspective view of the low voltage bobbin of the FBT having a first holder of the bleeder resistor holding device according to this invention;

FIGS. 7a and 7b are views showing the construction of the low voltage bobbin of this invention in more detail, in which:

FIG. 7a is a front view of the low voltage bobbin; and

FIG. 7b is a side view of the low voltage bobbin;

FIGS. 8a and 8b are views of the high voltage bobbin of the FBT having a second holder of the bleeder resistor holding device according to this invention, in which:

FIG. 8a is a view of the high voltage bobbin; and

FIG. 8b is a view of the second holder of the bleeder resistor holding device; and

FIGS. 9a and 9b are views of the assembled FBT, with a bleeder resistor installed in the FBT by the bleeder resistor holding device of this invention, in which:

FIG. 9a is a front view of the FBT; and

FIG. 9b is a plan view of the FBT.

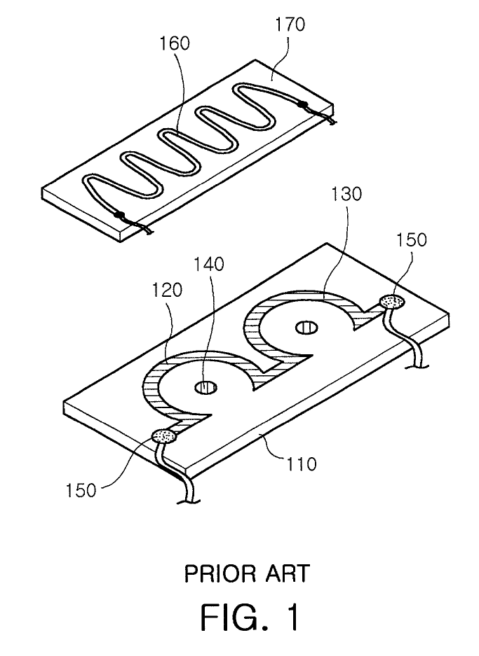

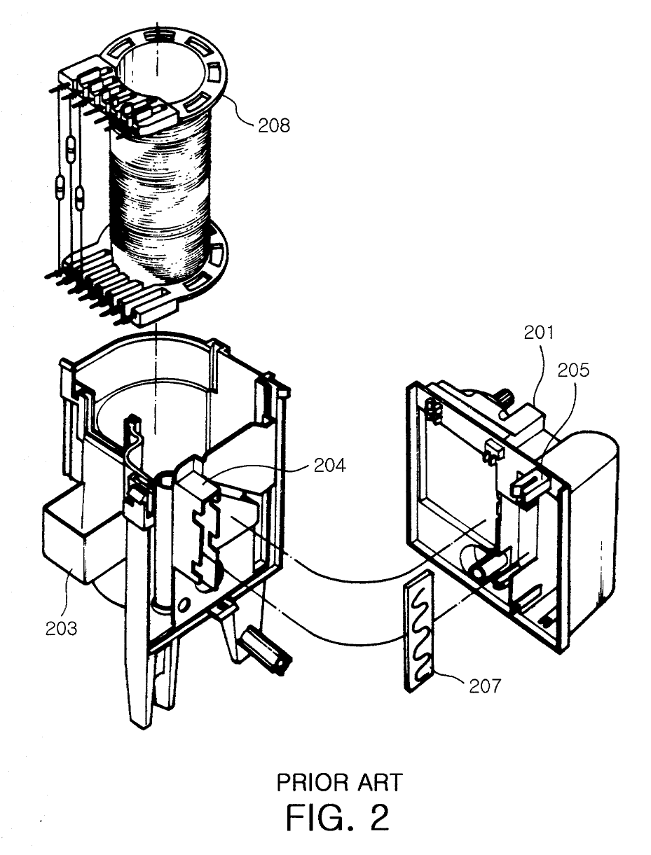

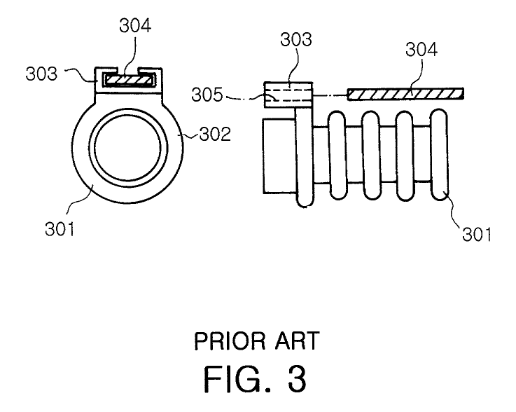

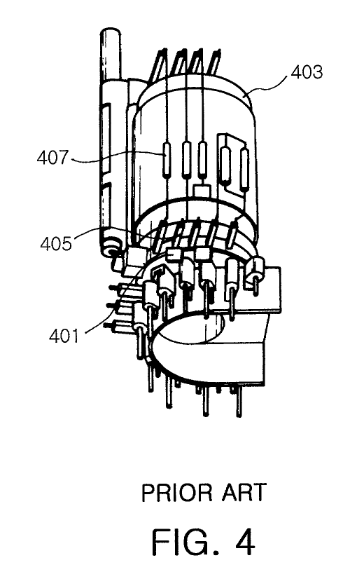

### DETAILED DESCRIPTION OF THE INVENTION

Reference now should be made to the drawings, in which the same reference numerals are used throughout the different drawings to designate the same or similar components.

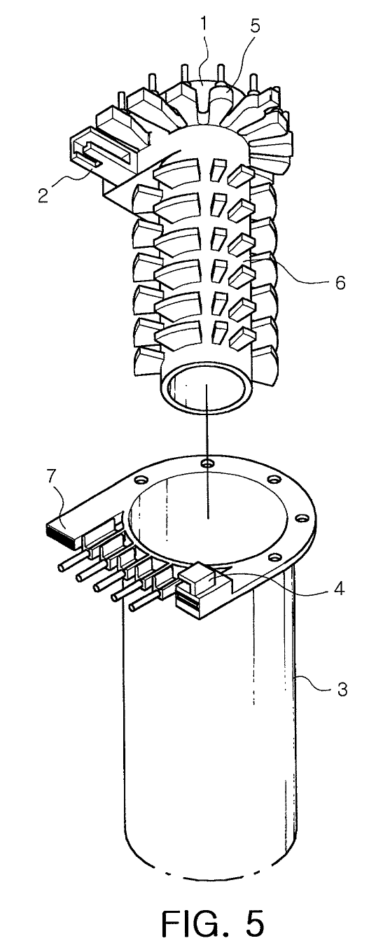

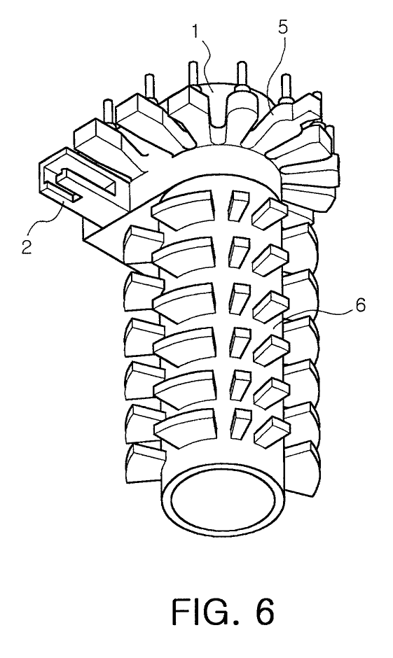

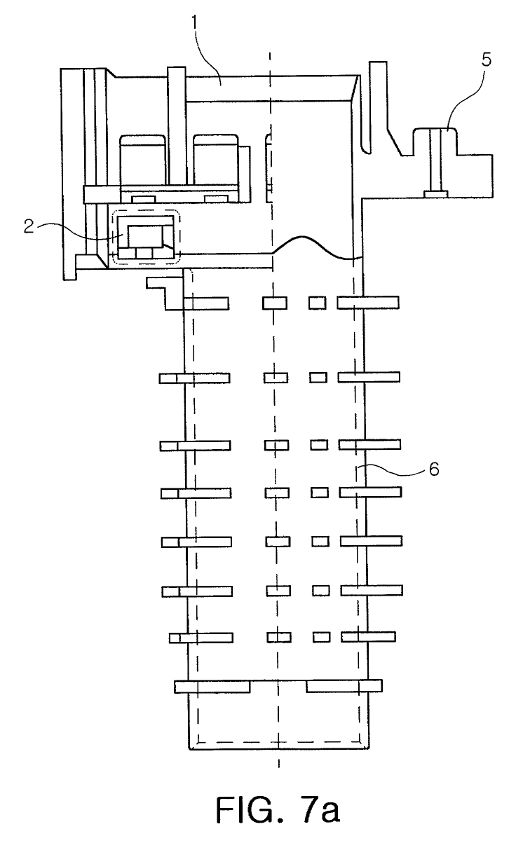

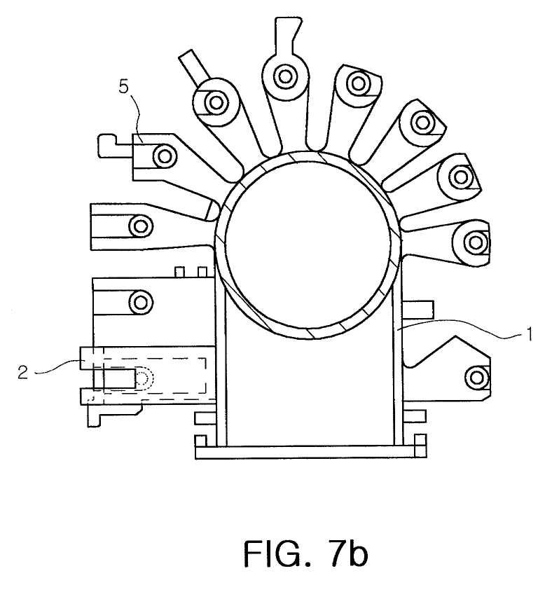

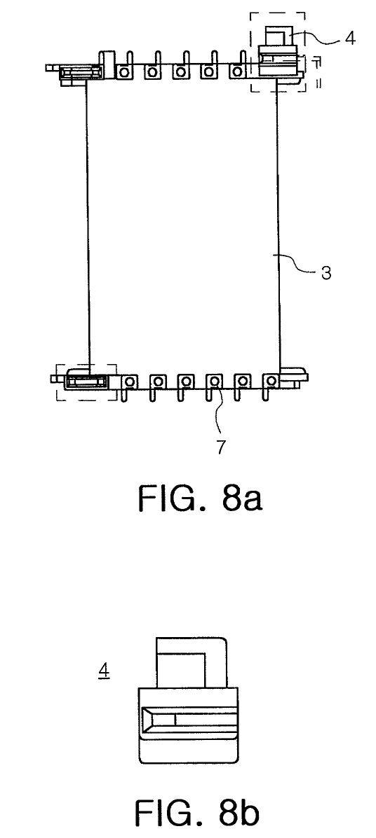

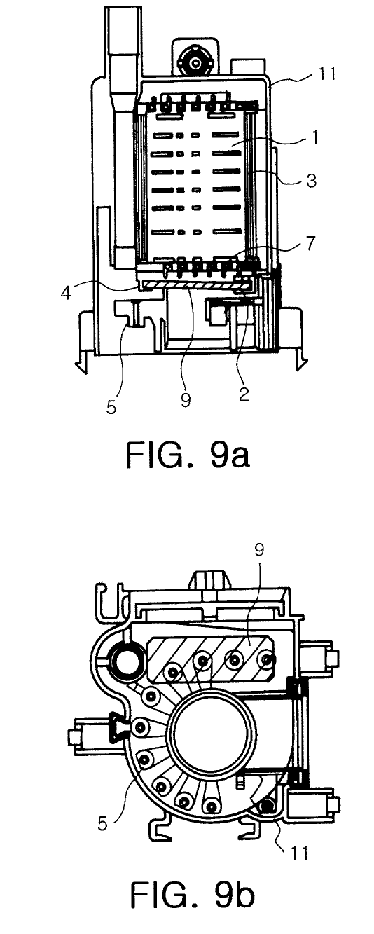

FIG. 5 is an exploded perspective view showing a high voltage bobbin and a low voltage bobbin of an FBT in accordance with the preferred embodiment of this invention. FIG. 6 is a perspective view of the low voltage bobbin having a first holder of a bleeder resistor holding device according to this invention. FIGS. 7a and 7b are views showing the construction of the low voltage bobbin of this invention in more detail. FIGS. 8a and 8b are views of the high voltage bobbin having a second holder of the bleeder resistor holding device according to this invention. FIGS. 9a and 9b are views of the FBT, with a bleeder resistor installed in the FBT by the bleeder resistor holding device of this invention.

As shown in the drawings, a high voltage bobbin 3 of the FBT is a hollow cylindrical body having a pin terminal 5 at one end thereof, and axially receives a low voltage bobbin 1 therein. The low voltage bobbin 1 has a first holder 2, while the high voltage bobbin 3 has a second holder 4. The first and second holders 2 and 4 project from the low voltage bobbin 1 and the high voltage bobbin 3, respectively, and form a bleeder resistor holding device of this invention. The two holders 2 and 4 of the bleeder resistor holding device receive the opposite ends of a bleeder resistor, thus holding the bleeder resistor in the FBT.

The construction of the first and second holders 2 and 4 are shown in detail in FIGS. 6 to 8b. As shown in FIGS. 6, 7a and 7b, the first holder 2 is formed on the low voltage bobbin 1 at a position under a pin terminal 5. This first holder 2 has a box shape, which is formed by top and bottom walls and has a channel defined between the top and bottom walls so as to receive one end of the bleeder resistor board. The bottom wall of the first holder 2 is slit along its central axis from the outer edge to a predetermined length, thus more easily receiving the bleeder resistor board in the channel of the first holder 2. The above first holder 2 is preferably formed at a position around the pin terminal 5, at which a voltage output coil is connected to the low voltage bobbin 1.

FIGS. 8a and 8b show the second holder 4 formed at the high voltage bobbin 3. As shown in FIG. 8a, the second holder 4 is formed on the high voltage bobbin 3 at a position above an output cable terminal 7. This holder 4 has a channel for receiving the other end of the bleeder resistor board. In a detailed description, the second holder 4 is formed on the high voltage bobbin 3 at a position corresponding to the first holder 2 of the low voltage bobbin 1, and so the opposite ends of the bleeder resistor board are inserted into the channels of the first and second holders 2 and 4, respectively.

In the present invention, the first and second holders 2 and 4 may be integrally formed on the bobbins 1 and 3. Alternatively, the holders 2 and 4 may be produced separate from the bobbins 1 and 3 prior to being attached to the bobbins 1 and 3 using an appropriate means, such as bonding agent or setscrews. The first and second holders 2 and 4 must be designed such that the bleeder resistor is spaced apart from the pin terminal 5 of the low voltage bobbin 1 by a predetermined distance when the board of the bleeder resistor is inserted at its opposite ends into the two holders 2 and 4. That is, when the low voltage bobbin 1 is assembled with the high voltage bobbin 3 into a single body, the bleeder resistor must be positioned at a gap defined between the pin terminals of the two bobbins 1 and 3. In such a case, the bleeder resistor must be spaced apart from the pin terminals of the bobbins 1 and 3 by the distance so as to prevent any interference of the bleeder resistor with the pin terminals.

The distance between the bleeder resistor and the pin terminal 5 of the low voltage bobbin 1 is preferably set to at least 1.0 mm. In order to accomplish the above object, the first holder 2 is preferably spaced apart from the pin terminal 5 of the low voltage bobbin 1 by at least 1.0 mm. In an operation of the FBT, a high voltage of about 10˜12 kV is typically generated at the bleeder resistor set in the first holder 2, while a low voltage of only several hundred volts is generated at the pin terminal 5 of the low voltage bobbin 1. Therefore, there is a potential difference of about 10˜12 kV between the first holder 2 and the pin terminal 5 of the low voltage bobbin 1, and so it is necessary to space the first holder 2 from the pin terminal 5 by at least 1.0 mm, and electrically insulate the pin terminal 5 from the first holder 2 by filling an epoxy resin in the gap between the first holder 2 and the pin terminal 5. Since the insulating power of the epoxy resin is at least 12 kV per 1 mm thickness, the epoxy resin filled in the gap between the first holder 2 and the pin terminal 5 effectively insulates the pin terminal 5 from the first holder 2. In the present invention, it is more preferable to space the first holder 2 from the pin terminal 5 of the low voltage bobbin 1 by at least 1.5 mm. In such a case, the distance between the bleeder resistor and the pin terminal 5 of the low voltage bobbin 1 is set to at least 1.5 mm.

The second holder 4 of the high voltage bobbin 3 is preferably spaced apart from the pin terminal 5 of the low voltage bobbin 1 by at least 2.5 mm. In an operation of the FBT, a high voltage of about 25˜30 kV is typically generated at the bleeder resistor set in the second holder 4, and so there is a potential difference of about 25˜30 kV between the second holder 4 and the pin terminal 5. It is thus necessary to space the pin terminal 5 from the second holder 4 by at least 2.5 mm, and insulate the pin terminal 5 from the second holder 4 by filling an epoxy resin in the gap between the second holder 4 and the pin terminal 5. In such a case, the epoxy resin, the insulation power of which is at least 12 kV per 1 mm thickness, effectively insulates the pin terminal 5 from the second holder 4.

FIGS. 9a and 9b are views of the assembled FBT, with a bleeder resistor installed in the FBT by the bleeder resistor holding device of this invention. The operational effect of the bleeder resistor holding device of this invention will be described herein below with reference to FIGS. 9a and 9b.

As shown in FIGS. 9a and 9b, in order to fabricate an FBT, the low voltage bobbin 1 having the first holder 2 is assembled with the high voltage bobbin 3 having the second holder 4 into a single body. In such a case, the board of a bleeder resistor 9 is inserted at its opposite ends into the holders 2 and 4 such that the bleeder resistor 9 is spaced apart from the pin terminal 5 of the low voltage bobbin 1 by a predetermined distance due to the specified positions of the two holders 2 and 4. The assembled bobbins 1 and 3 with the bleeder resistor 9 are inserted into an FBT casing 11 prior to injecting an epoxy resin into desired portions for accomplishing insulating effect. Thereafter, a ferrite core and a high voltage cable are set in the FBT casing 11, thus completely fabricating a desired FBT.

As shown in FIG. 9b, the bleeder resistor 9 is positioned at the gap defined between the pin terminals of the low voltage bobbin 1 and the high voltage bobbin 3. In such a case, the bleeder resistor 9 is installed in the FBT casing 11 without being exposed to the outside of the FBT casing 11. Due to the holders 2 and 4 formed on the bobbins 1 and 3, it is not necessary to secure additional space for installing the bleeder resistor in the FBT, and so compactness and smallness of the FBT is accomplished. Particularly, the bleeder resistor holding device of this invention desirably simplifies the structure of an FBT focus pack, and so it is possible to more effectively accomplish compactness and smallness of FBTs.

As described above, the present invention provides a bleeder resistor holding device for FBTs, which is designed to hold a bleeder resistor at a gap defined between a high voltage bobbin and a low voltage bobbin of an FBT. The bleeder resistor holding device of this invention thus accomplishes compactness and smallness of the FBTs and reduces the production cost of the FBTs, in addition to easily receiving the bleeder resistor when installing the bleeder resistor in an FBT.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A flyback transformer, comprising:
a high voltage bobbin and a low voltage bobbin, each provided with a pin terminal, in addition to an internal coil used for generating a high voltage;
a flyback transformer casing receiving both the high voltage bobbin and the low voltage bobbin, and electrically insulated by an insulating resin; and
a bleeder resistor consisting of a ceramic board printed with a resistor pattern on a top surface thereof, said bleeder resistor being positioned at a gap defined between the pin terminals of the high voltage bobbin and the low voltage bobbin such that the bleeder resistor is spaced apart from the pin terminal of said low voltage bobbin by a predetermined distance.

2. The flyback transformer according to claim 1, further comprising a board holding device projecting from at least one of the high voltage bobbin and the low voltage bobbin, said board holding device receiving an end of said ceramic board of the bleeder resistor for holding the bleeder resistor in the flyback transformer.

3. The flyback transformer according to claim 1, wherein the distance between the bleeder resistor and the pin terminal of the low voltage bobbin is not less than 1.0 mm.

4. The flyback transformer according to claim 2, wherein said board holding device consists of first and second holders, respectively projecting from the low voltage bobbin and the high voltage bobbin and receiving opposite ends of said ceramic board of the bleeder resistor to hold the bleeder resistor in the flyback transformer.

5. The flyback transformer according to claim 4, wherein the second holder projecting from the high voltage bobbin is spaced apart from the pin terminal of the low voltage bobbin by at least 2.5 mm, and the distance between the bleeder resistor and the pin terminal of the low voltage bobbin is not less than 2.5 mm.

6. The flyback transformer according to claim 4, wherein the first holder projecting from the low voltage bobbin is spaced apart from the pin terminal of the low voltage bobbin by at least 1.5 mm, and the distance between the bleeder resistor and the pin terminal of the low voltage bobbin is not less than 1.5 mm.

7. A device for holding a bleeder resistor in a flyback transformer including a bleeder resistor consisting of a ceramic board printed with a resistor pattern on a top surface thereof, and a high voltage bobbin and a low voltage bobbin each provided with an internal coil for generating a high voltage, comprising:
resistor holding means projecting from at least one of the high voltage bobbin and the low voltage bobbin at a position between pin terminals of the high voltage bobbin and the low voltage bobbin, said holding means receiving an end of said ceramic board of the bleeder resistor for holding the bleeder resistor in the flyback transformer,
whereby the bleeder resistor held by the holding means is positioned at a gap defined between the pin terminals of the high voltage bobbin and the low voltage bobbin such that the bleeder resistor is spaced apart from the pin terminal of said low voltage bobbin by a predetermined distance.

8. The device according to claim 7, wherein the resistor holding means consists of first and second holders, respectively projecting from the low voltage bobbin and the high voltage bobbin and receiving opposite ends of said ceramic board of the bleeder resistor to hold the bleeder resistor in the flyback transformer.

9. The device according to claim 8, wherein the second holder projecting from the high voltage bobbin is spaced apart from the pin terminal of the low voltage bobbin by at least 2.5 mm, and the distance between the bleeder resistor and the pin terminal of the low voltage bobbin is not less than 2.5 mm.

10. The device according to claim 8, wherein the first holder projecting from the low voltage bobbin is spaced apart from the pin terminal of the low voltage bobbin by at least 1.5 mm, and the distance between the bleeder resistor and the pin terminal of the low voltage bobbin is not less than 1.5 mm.
